(19) United States
(12) Patent Application Publication
(10) Pub. No.: US 2005/0060921 A1
(43) Pub. Date: Mar. 24, 2005

(54) Mobile audio/visual presentation system and method

(76) Inventor: Christopher G. Glynn, Los Angeles, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 10/916,088

(22) Filed: Aug. 10, 2004

Related U.S. Application Data
(60) Provisional application No. 60/494,284, filed on Aug. 11, 2003.

(51) Int. Cl. G09F 21/04

(52) U.S. Cl. 40/591

(57) ABSTRACT

A presentation system mountable on a truck, and method of operating the system. The system includes a frame securable to the truck, a post mounted to the frame, a plurality of panels rotatably attached to each other with each of the panels including an optical display and/or a speaker, a first motor connected to the post and one of the panels for rotating the panels relative to the post from a horizontal position to a vertical position, a plurality of second motors for rotating the panels away from each other from a folded position to an unfolded position, a pair of shells movably mounted to the frame for covering the panels when in the horizontal position, a third motor mounted to the frame for moving the pair of shells away from the panels, and a hydraulic pump connected to and for operating the first, second and third motors.

This application claims the benefit of U.S. Provisional Application No. 60/494,284 filed Aug. 11, 2003.

### FIELD OF THE INVENTION

The present invention relates to large screen optical displays, and more particularly to a mobile large screen optical display that can easily be deployed and moved from site to site.

### BACKGROUND OF THE INVENTION

Large optical display screens are well known. They include LED (light emission diode), plasma, and similar types of viewing screens that are permanently installed in outdoor locations such as Times Square, Las Vegas and Tokyo, as well as indoor or outdoor sports stadium complexes worldwide. These optical displays are built or attached to the building or stadium in a permanent or fixed mamier.

Additionally, giant optical displays can be bought or more commonly rented from companies such as Impact Video, Creative Concepts, or XL Video. These companies will transport the optical display to its desired location or event, and use a crew of people to assemble or stage up the display. When the use or event has concluded, the crew of people disassemble the display and send it back to storage.

To accommodate a larger audience and a more versatile application for these giant displays, a number of company's such as Samsung, Go Vision, Havavison, Daktronics and Impact Video have placed giant display screens on mobile platforms. The majority of these existing mobile display platforms are mounted to large semi tractor trailer vehicles or large moving trucks with the optical display built into the side of the truck. The reason for placing the display on large commercial truck platforms is that it is believed that the size and weight of these displays required a footprint as big as or larger than the display itself to transport, hold and deploy them, and to accommodate the production controls required to operate them.

These existing mobile large screen display systems are extremely limiting due to their size and slow rate of deployment. They are unable to transport the displays into the majority of usable areas do to the size of the base vehicle platform. Additionally, the end user of these existing bulky systems is generally limited to commercial applications. This is due to the cost, size and limited rate of deployment/use, all of which cause the cost of using these existing mobile systems to be prohibitive to the majority of businesses and events. Nearly all of the general population, individual consumers and small businesses are prevented from utilizing large display screen presentations because of the current limitations and costs of existing mobile systems.

There is a need for a mobile display system that provides a large screen optical display, that can be delivered, set-up, and stored using smaller and more compact truck delivery platforms, and without a crew of people to deploy and retrieve the system.

### SUMMARY OF THE INVENTION

The present invention solves the aforementioned problems by packaging a deployment system for a large screen optical display to fit into the spatial area of the smaller & significantly more compact consumer truck bed or SUV passenger & cargo areas.

The present invention is a presentation system mountable on a truck, and includes a post securable to the truck, a plurality of panels each rotatably attached to at least one of the other of the plurality of panels, wherein each of the panels includes at least one of an optical display and a speaker, a first motor connected to the post and one of the panels for rotating the panels relative to the post from a horizontal position to a vertical position, and at least one second motor for rotating the panels away from each other from a folded position to an unfolded position.

In another aspect of the present invention, the presentation system mountable on a truck includes a frame securable to the truck, a post mounted to the frame, a plurality of panels each rotatably attached to at least one of the other of the plurality of panels with each of the panels includes at least one of an optical display and a speaker, a first motor connected to the post and one of the panels for rotating the panels relative to the post from a horizontal position to a vertical position, at least one second motor for rotating the panels away from each other from a folded position to an unfolded position, at least one shell movably mounted to the frame for covering the panels when in the horizontal position, a third motor mounted to the frame for moving the at least one shell away from the panels, and a hydraulic pump connected to and for operating the first, second and third motors.

One further aspect of the present invention is a method of deploying a truck mounted presentation system having a post, a plurality of panels each rotatably attached to at least one of the other of the plurality of panels with each of the panels including at least one of an optical display and a speaker, and at least one shell covering the panels. The method includes removing the at least one shell from covering the panels, rotating the panels relative to the post from a horizontal position to a vertical position, and rotating the panels away from each other from a folded position to an unfolded position.

Other objects and features of the present invention will become apparent by a review of the specification, claims and appended figures.

### BRIEF DESCRIPTION OF THE DRAWINGS

FIG. 1 is a side view of the audio/visual presentation system of the present invention in its collapsed configuration.

FIG. 2 is an end view of the audio/visual presentation system of the present invention in its collapsed configuration.

FIG. 3 is a side view of the audio/visual presentation system of the present invention in its deployed configuration.

FIG. 4 is an end view of the audio/visual presentation system of the present invention in its deployed configuration.

FIG. 5 is a perspective view of the audio/visual presentation system of the present invention, without the shells and with the main display assembly in a slightly raised position.

FIG. 6 is a side perspective view of the audio/visual presentation system of the present invention, without the shells.

FIG. 7 is a side view of the audio/visual presentation system of the present invention, without the shells.

FIGS. 8A-8C are end views of the audio/visual presentation system of the present invention, illustrating the horizontal and vertical movements of the shells.

FIG. 9 is a perspective view of the main display assembly of the present invention in its folded position.

FIG. 10 is a bottom view of the main display assembly of the present invention in its folded position.

FIG. 11 is a front perspective view of the main display assembly of the present invention, with the panels extended in their unfolded positions, and the optical displays and speakers mounted to the panels.

FIG. 12 is a back perspective view of the main display assembly of the present invention, with the panels extended in their unfolded positions, and the optical displays and speakers not mounted to the panels.

FIG. 13 is a perspective view of the side display assembly of the present invention in its folded position.

FIG. 14 is a perspective view of the side display assembly of the present invention in its unfolded position.

FIG. 15 is an end view of the shell containing the side display assembly of the present invention.

FIG. 16 is a schematic diagram of the components of the audio/visual presentation system of the present invention.

### DETAILED DESCRIPTION OF THE PREFERRED EMBODIMENTS

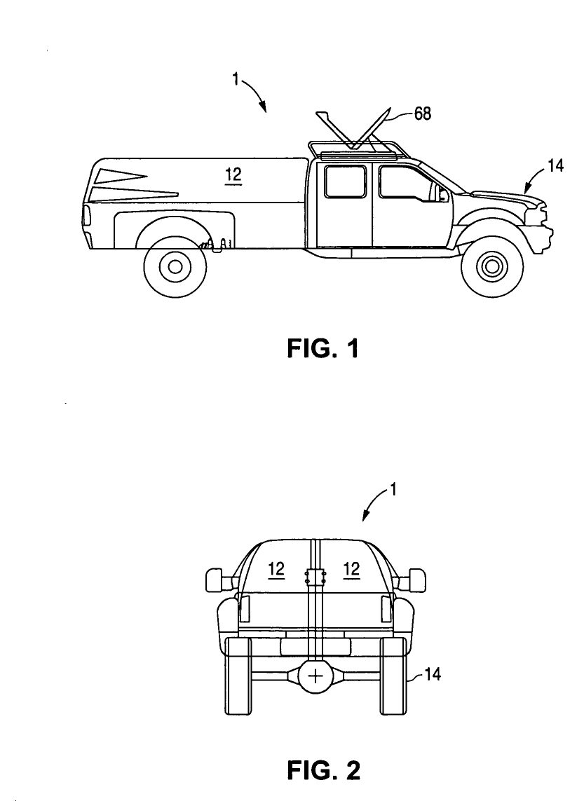

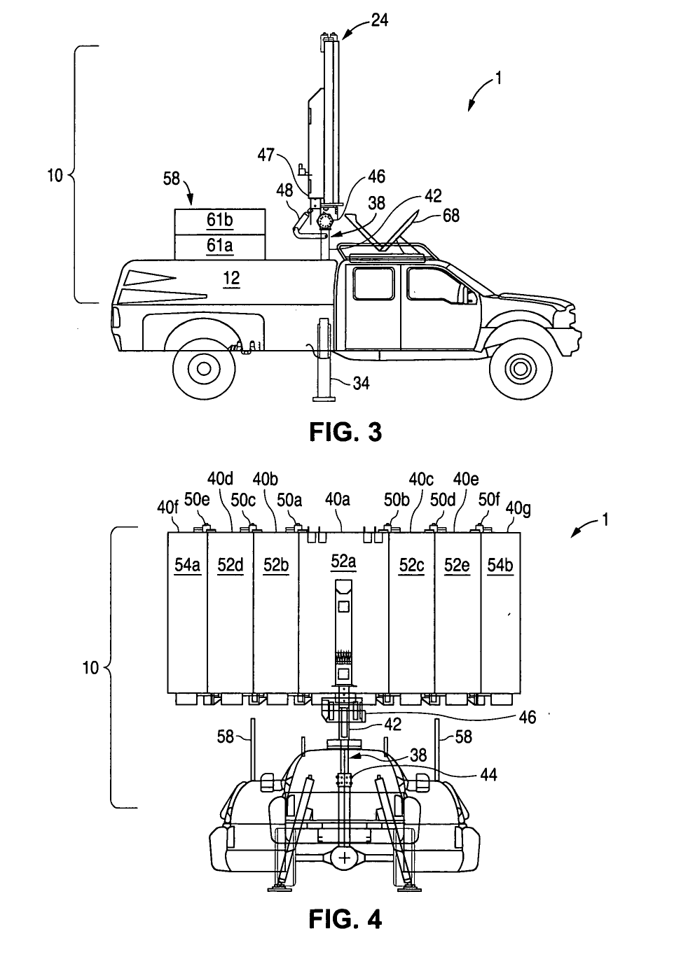

The mobile audio/visual presentation system 1 of the present invention is illustrated in FIGS. 1-4, and includes a collapsible and self contained presentation assembly 10 covered by a pair of protective shells 12, all mounted on the back of a truck 14. The invention is described in the context of an extended cab truck (e.g. a Ford F550 truck), but can be implemented on any cab chassis type truck. FIGS. 1 and 2 illustrate the presentation assembly 10 in its folded (collapsed) configuration or position (and covered by shells 12), and FIGS. 3 and 4 illustrate the presentation assembly 10 in its unfolded (deployed) configuration or position. The present invention provides a large optical viewing screen with speakers (e.g. 222 inches wide and 106 tall) that folds into the bed size of a standard truck (e.g. truck length under 25 feet, bed size less than 13 feet), for easy transportation from site to site.

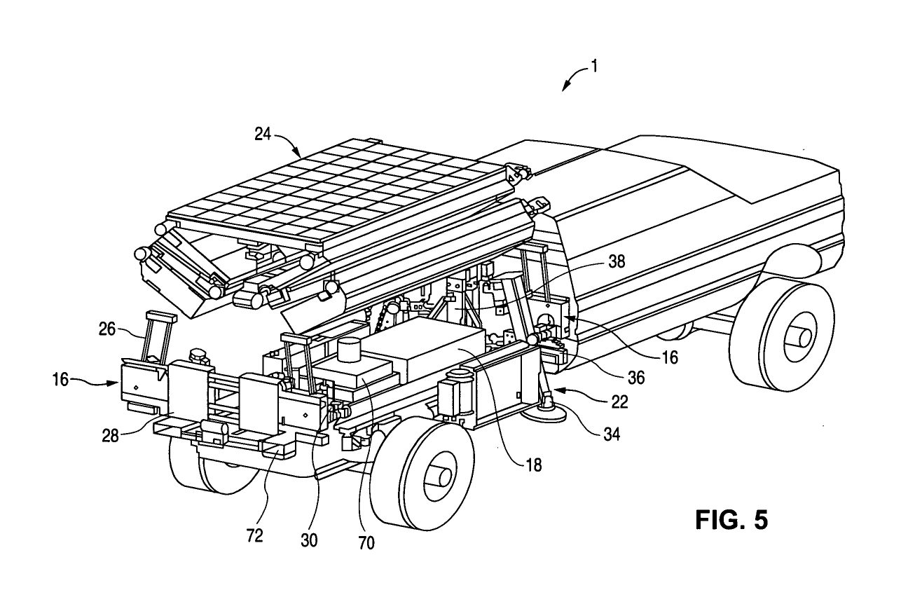

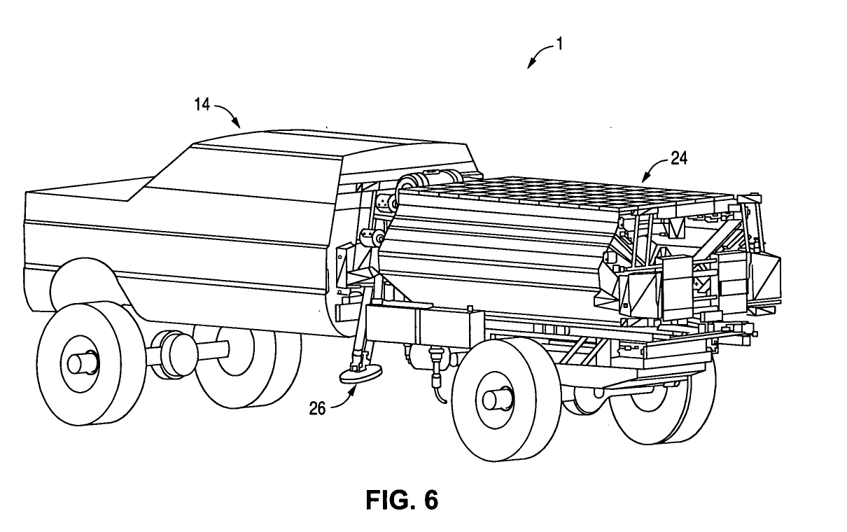

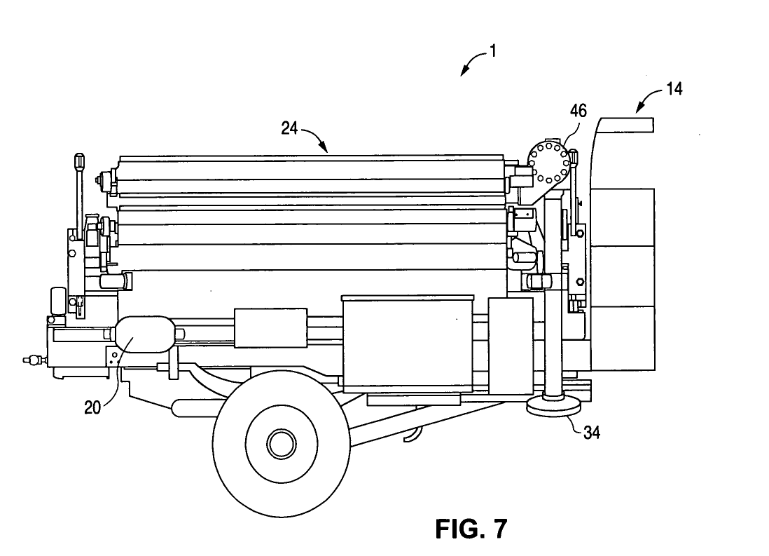

FIGS. 5-7 illustrate the truck 14 and presentation assembly 10 without the shells 12. The presentation assembly 10 includes a pair of shell manipulation assemblies 16, a generator 18, a hydraulic source pump 20, a pair of stabilizer assemblies 22, and a main display assembly 24.

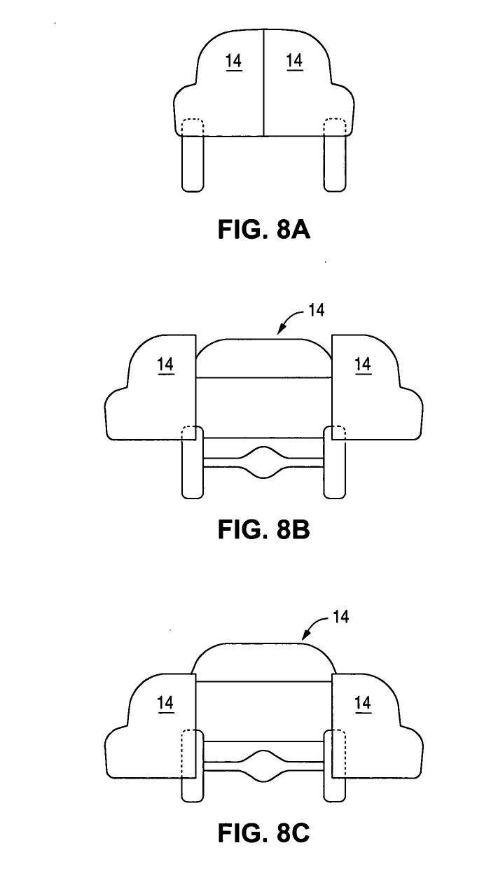

The shell manipulation assemblies 16 each include a pair of support arms 26 on which the shells 12 are mounted. A motor 28 rotates a threaded shaft for separating the support arms 26. Another motor 30 is used to raise and lower the support arms 26 (and thus the shells 12 mounted thereto) relative to the ground. It should be noted that the various motors explained herein can be electric or hydraulic, but it is preferable that many if not all of the motors used and described with respect to the present invention are hydraulic actuators/motors, all operated by a single hydraulic source pump 20 via hydraulic lines (not shown). Using a single hydraulic source pump 20 to operate hydraulic actuators/motors throughout the system conserves space, which is important in fitting the entire presentation assembly 10 under shells 12. Hydraulic source pump 20 is powered by the electrical generator 18, which is preferably a 21 KW unit. To open shells 12, motor 28 translates the shells laterally to the side of the truck bed, and motor 30 translates the shells vertically toward the ground once the shells clear the side of the truck, as illustrated in FIG. 8.

Stabilizer assemblies 22 each include a stabilizer support shaft 34 and a motor 36. Motors 36 lower stabilizer support shafts 34 until they engage with the ground to secure the truck in place and keep the truck from rocking while the presentation assembly 10 is deployed.

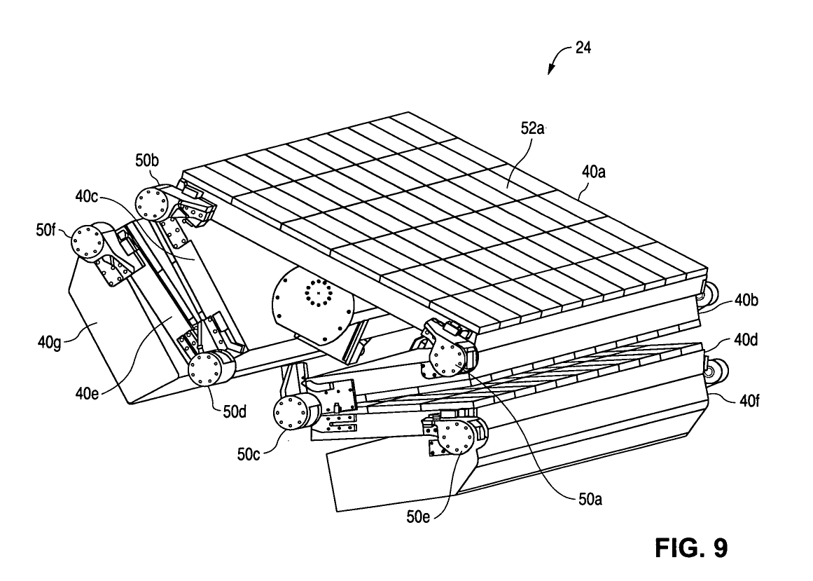

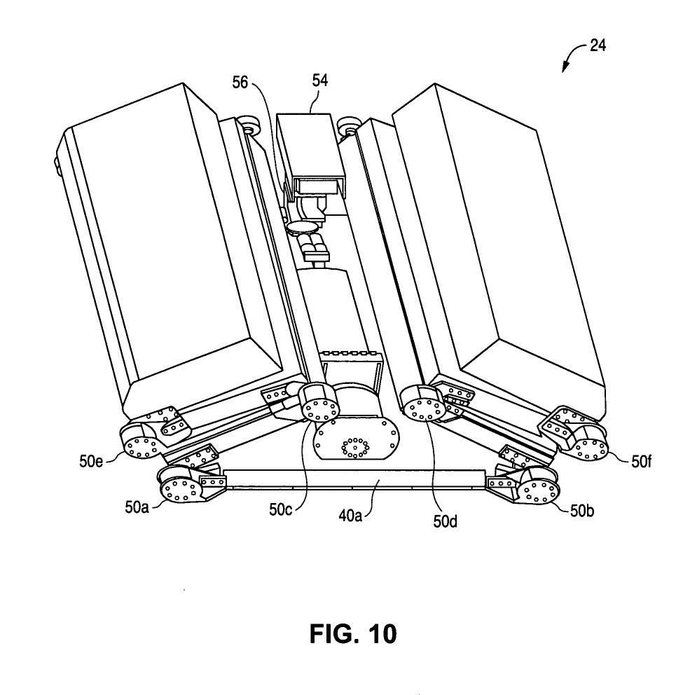

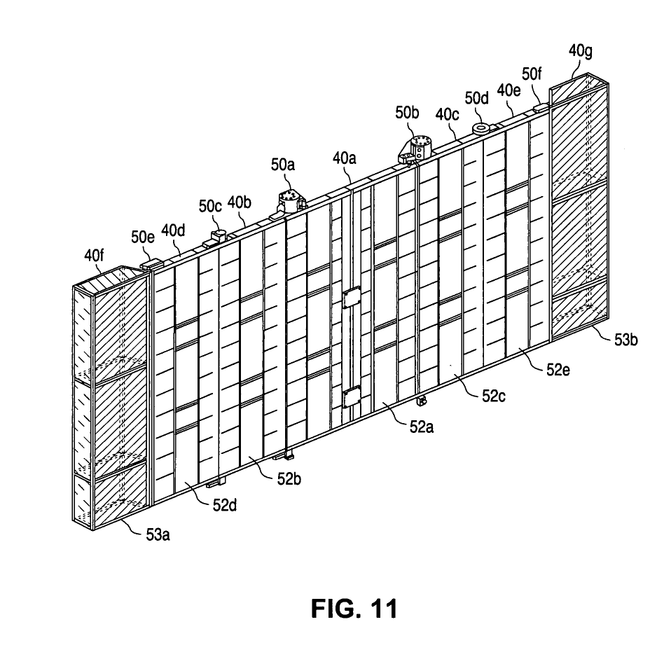

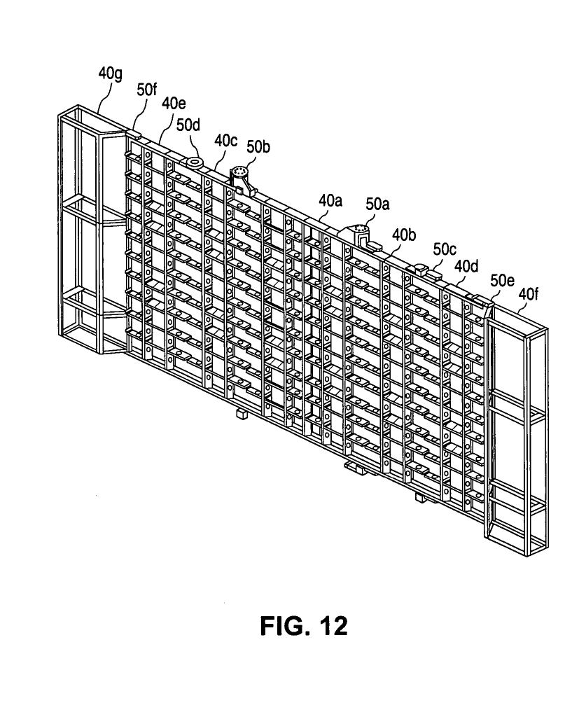

The main display assembly 24 is best illustrated in FIGS. 3-5 and 9-12, and includes a support assembly 38, and a plurality of support panels 40a, 40b, 40c, 40d, 40e, 40f and 40g rotatably attached together. Support assembly 38 includes a post 42 that is moved or telescoped upwardly by a motor 44. Panel 40a is rotatably attached to post 42 between a horizontal position (as shown in FIG. 5) and a vertical position (as shown in FIGS. 3 and 4). A rotational motor 46 along with a piston arm 48 are used to rotate panel 40a relative to post 42 between the horizontal and vertical positions. An optional motor 47 can be used to rotate the panel 40a about an axis of rotation that is parallel to post 42. Support panels 40a-40g are rotatably connected together and can fold between a folded position (see FIGS. 5, 9, 10) where the panels are disposed in a generally stacked configuration and an unfolded position (see FIGS. 3, 4, 11, 12) where the panels are disposed in a generally co-planar configuration. Motors 50a-50f control the rotation of the panels 40a-40g relative to each other. Preferably, LED optical displays 52a-52e are attached to panels 40a-40e, and speakers 54a-54b are attached to panels 40f-40g. LED optical displays are well known in the art, and are available from Barco, Saco, Samsung, Mitsubishi, etc. The optical displays for the preferred embodiment include a plurality of display segments that attach to each of the panels 40a-40e, so that a damaged display segment can be replaced without replacing the entire display on any given panel 40a-40e. Alternately, other types of optical displays can be used (such as LCD, plasma, etc.), but LED optical displays are preferred because they are more durable than other types of optical displays. An optional camera 54 is attached to panel 40a, preferably in a rotational manner with a motor 56 controlling the rotational movement of the camera.

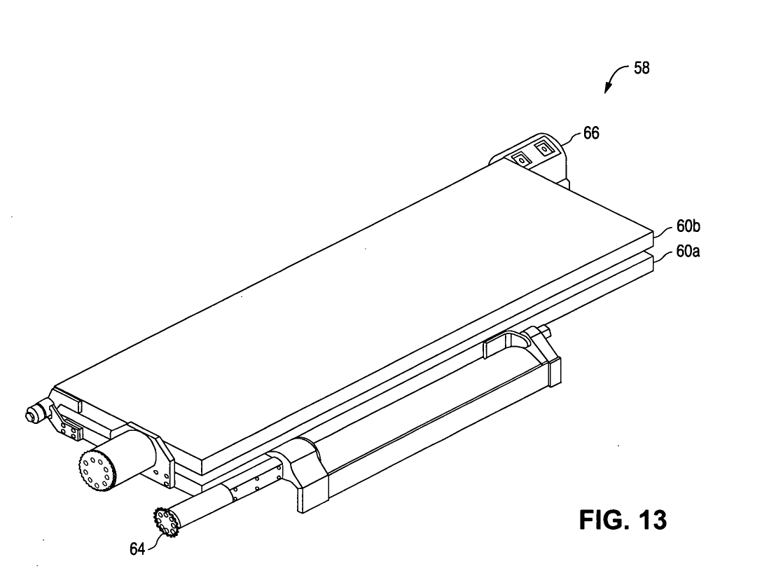

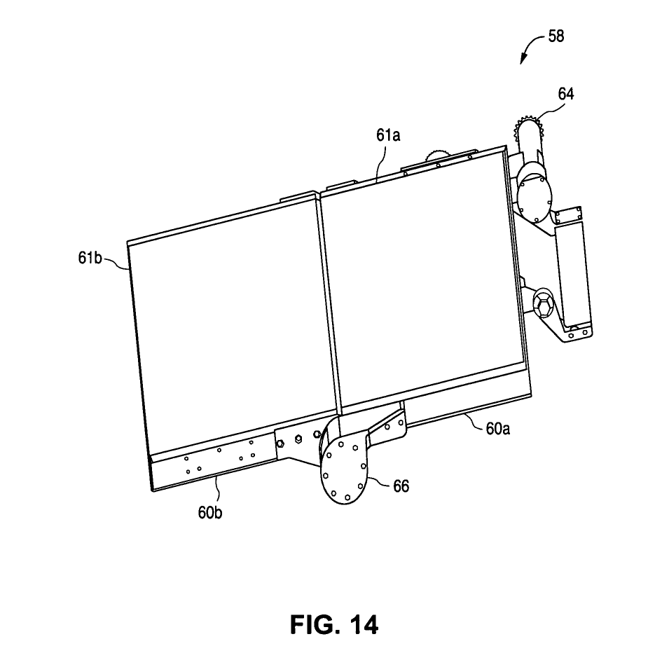

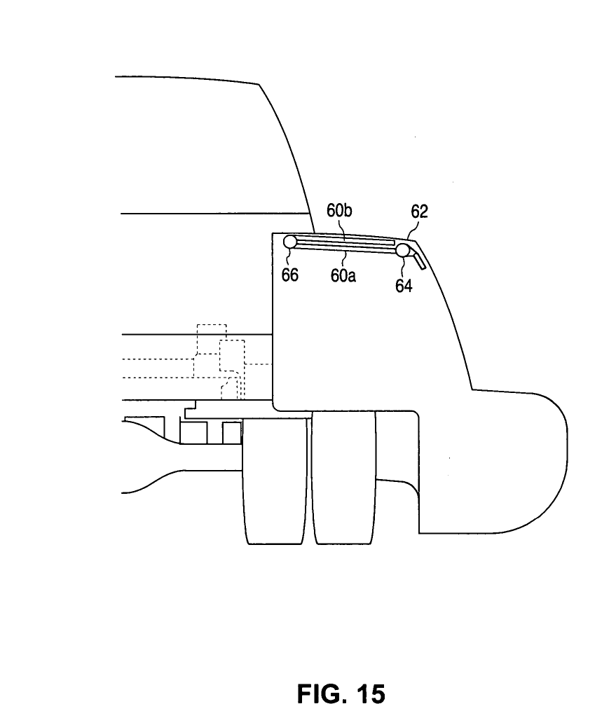

Optional side display assemblies 58 can be mounted to the shells 12, as illustrated in FIGS. 3-4 and 13-15. Side display assemblies 58 each include a pair of foldable panels 60a-60b (on which optical displays 61a-61b are mounted), which are mounted underneath the top wall 62 of one of the shells as shown in FIG. 15. The top wall 62 of each shell 12 includes a removable segment that exposes panels 60a-60b. A first motor 64 controls the rotation of the panel 60a relative to the shell 12, and a second motor 66 controls the rotation of panels 60a-60b relative to each other.

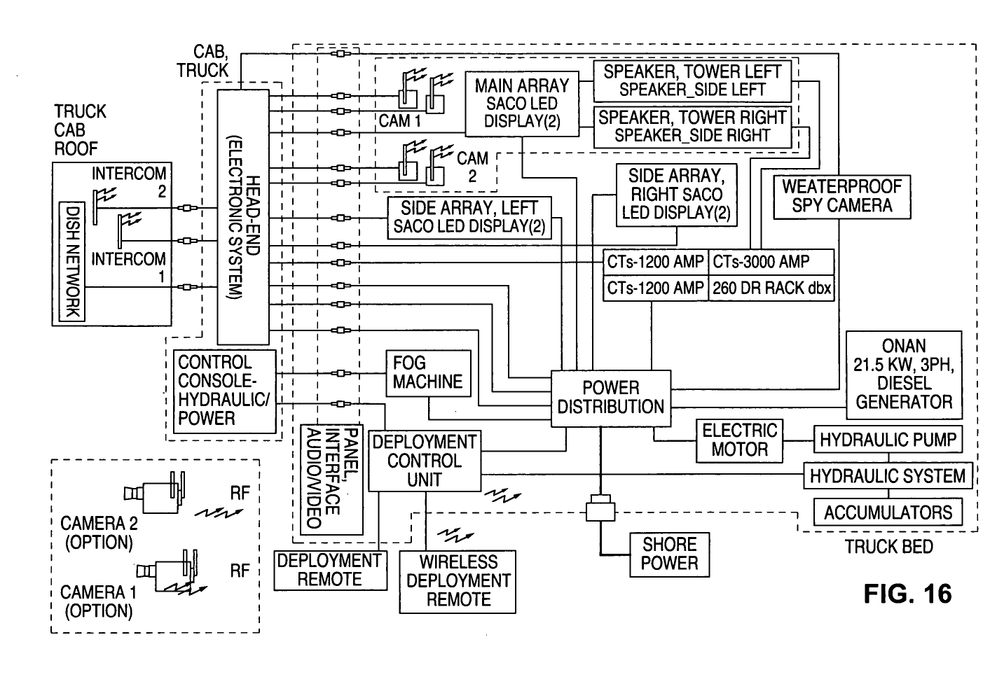

FIG. 16 is a schematic diagram showing the interconnections between the various components of the system. The system can further include a satellite dish 68 on the truck cab, a fog machine 70 for producing fog streams from the system, a shore power connector for using external power to operate the system, and remote/wireless connectivity for operating the system remotely. The control electronics can be located in the truck cab, in the truck bed, or externally to the truck.

Preferably, the entire presentation assembly 10, including the pair of shell manipulation assemblies 16, generator 18, hydraulic source pump 20, stabilizer assemblies 22, and main display assembly 24 are all mounted to a frame 72 that includes fork lift guides, so the entire system can be easily and quickly removed from the truck bed. Preferably, the frame 72 is attached to the truck bed via quick release bolts.

The deployment of the mobile audio/visual presentation system I of the present invention is as follows. Once the truck 14 is parked in a desired location (see FIGS. 1-2), motors 36 are activated to lower support shafts 34 down to the ground (to stabilize the truck). Motors 28 are then activated to slide the shells 12 (see FIG. 8A) laterally away from each other until they clear the side of the truck (see FIG. 8B). Motors 30 are then activated to lower the shells 12 toward the ground (see FIG. 8C), which exposes the main display assembly 24. Motor 44 is next activated, to slide post 42 vertically (i.e. vertically raise post 42 and panels 40a-g attached thereto). Then, motor 46 and piston 48 are activated to rotate the panels 40a-g from a horizontal position to a vertical position. Motors 50a-50f are then activated to unfold the panels 40a-40g. Preferably, this is performed sequentially by activating motors 50a and 50b to unfold panels 40b and 40c from 40a, then motors 50c and 50d to unfold panels 40d and 40e from panels 40b and 40c, and then motors 50e and 50f to unfold panels 40f and 40g from panels 40d and 40e. If desired, motor 47 can be activated to rotate the unfolded panels 40a-40g about the center of panel 40a so that the panels face the desired direction (this could be continuous rotation as part of a show surrounding the truck).

If optional side display assemblies 58 are included, they are deployed by sliding off the removable segments from the top walls 62 of shells 12, activating motors 64 to rotate the panels 60a-60b up relative to shells 12, and activating motors 66 to rotate panels 60b relative to 60a (i.e. unfold panels 60a-60b).

The fully deployed mobile audio/visual presentation system I of the present invention is illustrated in FIGS. 3-4. To retract the system, the above steps are performed in reverse order. Preferably the shells 12 includes slots or removable slats so that the shells 12 can be lifted and slid back to their closed position with the main display assembly 24 and side display assemblies 58 fully deployed (as shown in FIG. 3).

The present invention provides a multi-segment viewing/speaker display (e.g. 222 inches wide and 106 tall) that folds into the bed size of a standard truck (e.g. truck length under 25 feet), which can be fully deployed or collapsed in a matter of minutes. Generator 18 provides the power necessary to deploy and retract the presentation assembly 10, as well as to operate the optical displays 52a-52e and speakers 53a-53b. Preferably, the deployment steps described above are performed sequentially, without any overlap, to reduce the size and power required from generator 18 and hydraulic source pump 20.

The present invention has many advantages. It takes an expensive and limited technology and expands its availability to a substantially larger customer base at a much lower cost. The system has many applications for its use, ranging from concerts, sporting events, conventions, tradeshows, community gatherings, small business promotions, private parties as well as purchase or rental use by the individual consumer. In addition, the system can act as a highly effective communications tool for governments and militaries around the world, as well as for political campaigns, civil emergencies, weather related disasters, disease control, third world mobile classrooms or battlefield deployments in forward or rear area communication centers. The invention can includes a satellite dish for receiving satellite signals for display by the optical displays. The system preferably includes a powerful sound system, amplifiers, video projector, computer and wireless components, electrical & hydraulic systems as well as special effects, designed to all fit into any consumer truck or SUV cab chassis. The system will automatically assemble, in less than 2 minutes, from a form fitted shell package designed to attach to the back of any heavy duty consumer or military class truck, such as but not limited to, Dodge, GMC, Chevy, Hummers, or the Ford F Series F150, F250, F350, F550 and F650 trucks.

Essentially, the invention is a mobile Jumbo-tron with a concert-like sound system that can be taken anywhere, then deployed and recovered by one person within 2 minutes or less. The invention has been reduced to practice where a large, 180 square foot main LED screen automatically opens up to a dimension of up to 15-feet horizontally and 9-feet vertically or larger, creating an enormous high-impact, multi-media experience. A multiple number of units can be networked together to form an outdoor, closed circuit, high-definition audio-visual broadcasting system.

It is to be understood that the present invention is not limited to the embodiment(s) described above and illustrated herein, but encompasses any and all variations falling within the scope of the appended claims. For example, materials, processes and numerical examples described above are exemplary only, and should not be deemed to limit the claims. Further, as is apparent from the claims and specification, not all method steps need be performed in the exact order illustrated. For example, in deploying the presentation assembly 10, motor 46 could be activated to move the main display assembly 24 into is vertical position before motor 44 is activated to vertically raise post 42. The present invention is described using a seven panel assembly (five panels for optical displays and two panels for speakers), however, fewer or additional panels could be used. Panels 40a-40e could integrally include the optical displays, and panels 40f-40g could integrally include the speakers. If extra space is required, the generator 18 can be removed from the truck bed, and towed behind the truck. The shell could open up in a different manner, such as like a flower, which folds down on the ground. Or, the shell could open at a hinge either at the rear or near the cab, which would open fully vertical to allow the screen out, or could simply be taken off and reattached manually. The shell could even be a box configuration attachable to the truck chassis which simply lifts off. Lastly, one or more of the panels could include both a speaker and an optical display.

1. A presentation system mountable on a truck, comprising:
a post securable to the truck;
a plurality of panels each rotatably attached to at least one of the other of the plurality of panels, wherein each of the panels includes at least one of an optical display and a speaker;
a first motor connected to the post and one of the panels for rotating the panels relative to the post from a horizontal position to a vertical position; and
at least one second motor for rotating the panels away from each other from a folded position to an unfolded position.

2. The system of claim 1, wherein the panels are disposed in a generally stacked configuration in the folded position, and are disposed in a generally co-planar configuration in the unfolded position.

3. The system of claim 1, wherein the panels rotate in a lateral direction from the folded position to the unfolded position.

4. The system of claim 1, further comprising:
a hydraulic pump connected to and for operating the first and second motors.

5. The system of claim 4, further comprising:
an electrical generator for supplying electrical power to the hydraulic pump.

6. The system of claim 1, further comprising:
a pair of shells for covering the panels when in the horizontal position; and
a third motor for moving the shells away from the panels.

7. The system of claim 6, wherein the third motor moves the shells laterally, away from each other, the system further comprising:
at least one fourth motor for moving the shells vertically.

8. The system of claim 7, further comprising:
a hydraulic pump connected to and operating the first, second, third and fourth motors.

9. The system of claim 6, further comprising:
a second plurality of panels each rotatably attached to at least one of the-other of the second plurality of panels, wherein each of the second plurality of panels includes at least one of an optical display and a speaker;
a fourth motor connected to one of the shells and one of the second plurality of panels for rotating the second plurality of panels relative to the one shell from a horizontal position to a vertical position; and
at least one fifth motor for rotating the second plurality of panels away from each other from a folded position to an unfolded position.

10. The system of claim 9, wherein the one shell includes a top wall with a removable segment for exposing the second plurality of panels.

11. The system of claim 1, further comprising:
a third motor for moving the post vertically to raise and lower the plurality of panels.

12. The system of claim 11, further comprising:
a hydraulic pump connected to and operating the first, second, and third motors.

13. The system of claim 1, further comprising:
a third motor for rotating the plurality of panels about an axis of rotation parallel to the post.

14. The system of claim 1, further comprising:
a plurality of support shafts slidably securable to the truck; and
at least one third motor for extending the support shafts downwardly until the support shafts engage a surface on which the truck is disposed.

15. The system of claim 1, further comprising:
a camera attached to one of the panels; and
a third motor for moving the camera relative to the one panel.

16. The system of claim 6, further comprising:
a frame securable to the truck, wherein the post, the pair of shells and the third motor are mounted on the frame, and wherein the frame includes a pair of fork lift receptacles for placement on and removal of the frame onto and off of the truck.

17. A presentation system mountable on a truck, comprising:
a frame securable to the truck;
a post mounted to the frame;
a plurality of panels each rotatably attached to at least one of the other of the plurality of panels, wherein each of the panels includes at least one of an optical display and a speaker;
a first motor connected to the post and one of the panels for rotating the panels relative to the post from a horizontal position to a vertical position;
at least one second motor for rotating the panels away from each other from a folded position to an unfolded position;
at least one shell movably mounted to the frame for covering the panels when in the horizontal position;
a third motor mounted to the frame for moving the at least one shell away from the panels; and
a hydraulic pump connected to and for operating the first, second and third motors.

18. The system of claim 17, wherein the panels are disposed in a generally stacked configuration in the folded position, and are disposed in a generally co-planar configuration in the unfolded position.

19. The system of claim 17, wherein the panels rotate in a lateral direction from the folded position to the unfolded position.

20. The system of claim 17, further comprising:
an electrical generator for supplying electrical power to the hydraulic pump and the optical displays.

21. The system of claim 17, wherein the third motor laterally moves the at least one shell laterally away from the panels, the system further comprising:
at least one fourth motor for moving the at least one shell vertically.

22. The system of claim 21, wherein the hydraulic pump is connected to and operates the fourth motor.

23. The system of claim 17, further comprising:
a second plurality of panels each rotatably attached to at least one of the other of the second plurality of panels, wherein each of the second plurality of panels includes at least one of an optical display and a speaker;
a fourth motor connected to the at least one shell and one of the second plurality of panels for rotating the second plurality of panels relative to the at least one shell from a horizontal position to a vertical position; and
at least one fifth motor for rotating the second plurality of panels away from each other from a folded position to an unfolded position.

24. The system of claim 23, wherein the at least one shell includes a top wall with a removable segment for exposing the second plurality of panels.

25. The system of claim 17, further comprising:
a fourth motor for moving the post vertically to raise and lower the plurality of panels.

26. The system of claim 25, wherein the hydraulic pump is connected to and operates the fourth motor.

27. The system of claim 17, further comprising:
a fourth motor for rotating the plurality of panels about an axis of rotation parallel to the post.

28. The system of claim 17, further comprising:
a plurality of support shafts slidably securable to the truck; and
at least one fourth motor for extending the support shafts downwardly until the support shafts engage a surface on which the truck is disposed.

29. The system of claim 17, further comprising:
a camera attached to one of the panels; and
a fourth motor for moving the camera relative to the one panel.

30. A method of deploying a truck mounted presentation system having a post, a plurality of panels each rotatably attached to at least one of the other of the plurality of panels with each of the panels including at least one of an optical display and a speaker, and at least one shell covering the panels, the method comprising:
removing the at least one shell from covering the panels;
rotating the panels relative to the post from a horizontal position to a vertical position; and
rotating the panels away from each other from a folded position to an unfolded position.

31. The method of claim 30, wherein the panels are disposed in a generally stacked configuration in the folded position, and are disposed in a generally co-planar configuration in the unfolded position.

32. The method of claim 30, wherein the rotating of the panels away from each other includes rotating the panels in a lateral direction from the folded position to the unfolded position.

33. The method of claim 30, wherein the at least one shell includes a pair of shells, and wherein the removing of the at least one shell includes moving the pair of shells away from the panels.

34. The method of claim 30, wherein the at least one shell includes a pair of shells, and wherein the removing of the at least one shell includes:
moving the pair of shells laterally away from each other, and then
moving the pair of shells vertically.

35. The method of claim 30, wherein the at least one shell further includes a second plurality of panels each rotatably attached to at least one of the other of the second plurality of panels, wherein each of the second plurality of panels includes at least one of an optical display and a speaker, the method further comprising:
rotating the second plurality of panels relative to the at least one shell from a horizontal position to a vertical position; and
rotating the second plurality of panels away from each other from a folded position to an unfolded position.

36. The method of claim 30, further comprising:
rotating the plurality of panels about an axis of rotation parallel to the post.

37. The method of claim 30, wherein the system further includes a plurality of support shafts slidably securable to the truck, the method further comprising:
extending the plurality of support shafts downwardly until the support shafts engage a surface on which the truck is disposed.

38. The method of claim 30, wherein the system further includes a camera rotatably attached to one of the panels, the method further comprising:
moving the camera relative to the one panel.
